(19) United States
(12) Patent Application Publication
(10) Pub. No.: US 2003/0173010 A1
(43) Pub. Date: Sep. 18, 2003

(54) Pneumatic tire, for vehicles

(76) Inventor: Dieter Ammon, Remseck-Aldingen (DE)

Correspondence Address: KLAUS J. BACH & ASSOCIATES, 4407 TWIN OAKS DRIVE, MURRYSVILLE, PA, 15668, US

(21) Appl. No.: 10/374,692

(22) Filed: Feb. 25, 2003

(30) Foreign Application Priority Data
Feb. 26, 2002 (DE) 102 08 273.1

(51) Int. Cl. B60C 1/00; B60C 11/00

(52) U.S. Cl. 152/209.4; 152/209.5

(57) ABSTRACT

In a tire for a vehicle, in particular multitrack motor vehicles, with a tire contact region, which comes into contact with a road surface during movement of the vehicle and serves for transferring shearing forces effectively parallel to the road surface between the tire and the road surface, the contact region is so constructed that its rigidity in the rolling direction is less than its rigidity transversely to the rolling direction of the tire in order to improve the lateral force transfer capability of the tire.

### BACKGROUND OF THE INVENTION

The invention relates to a pneumatic tire for a vehicle, in particular for a multi-track motor vehicle, with an area that comes into contact with the road surface.

DE 199 45 264 A1 discloses a pneumatic tire of the type referred to above which has a road contact area at its circumference. With this contact area, the tire rolls along a road and transfers shearing forces acting parallel to the road surface between the road and the tire.

When accelerating and while braking and when there are transverse acceleration forces, for example, when driving around bends, side forces occur between the vehicle and the road and these forces are transferred between the vehicle and the road via the tires. The transfer of the side forces depends on the friction coefficient effective between the road surface and the tire contact area. Also of decisive significance for the transferable forces are the contact kinematics between the contact area of the tire and the road, determined by the construction of the tire and by the wheel control. These contact kinematics inevitably cause relative movements between the road surface and the tire, in particular when driving around a bend, at least in regions of the contact area, which are momentarily in contact with the road surface, thereby causing shear stresses in the contact area of the tire. To transfer the shear forces, the contact area of the tire or individual lugs forming the contact area is or are reversibly deformed in the direction of the shearing forces, resulting in a shear strain in the contact area or of the individual lugs. The magnitude of the shear strain depends on the shear forces transferred. However, the shear forces are distributed differently over the contact zone between the road surface and the contact area, which is attributable to the contact kinematics and the ground pressure distribution along the contact zone.

Usually, the shear strain increases along the contact zone, extending from a beginning to an end of contact with the road surface, with the transferred shearing forces increasing at the same time. As soon as the transferred shearing forces reach the static friction limit between the contact region and the road surface, the transferable shearing forces drop to the value of sliding friction. In the case of conventional tires, the shear deformations, and consequently the transferable shearing forces, increase linearly or slightly progressively over the length of the contact zone. The static friction potential physically possible therefore, generally is not fully utilized with regard to the important cornering guidance or road grip.

In known tires, the static friction potential can be better utilized if the contact area of the tire is formed or constructed in such a way that the build-up of shear deformation takes place degressively along the length of the contact zone. By this measure, the portions of the contact zone closer to the beginning are utilized to a greater extent for the shear force transfer, so that overall the road grip for the tire is improved.

To improve the transferability of lateral forces via the tire, it is known, for example from DE 198 36 440 A1, to camber the tires or the wheels when driving through a bend, in order to allow much higher lateral forces to be supported by suitable shaping of the contact area—in a way similar to a motorcycle tire. However, the cambering of the wheel is accompanied by torsion of the contact zone, which results in additional longitudinal deflections of the lugs, which, although exploiting the adhesion potential of the contact zone, do not improve the transfer of lateral forces.

It is the object of the present invention to provide a tire which can in particular transfer high lateral forces.

### SUMMARY OF THE INVENTION

In a tire for a vehicle, in particular a multitrack motor vehicle, with a tire contact region, which comes into contact with a road surface during movement of the vehicle and serves for transferring shearing forces effectively parallel to the road surface between the tire and the road surface, the contact region is so constructed that its rigidity in the rolling direction is less than its rigidity transversely to the rolling direction of the tire in order to improve the lateral force transfer capability of the tire.

The present invention is based on the general idea of providing a greater transverse tire rigidity, that is, a tire whose rigidity transverse to the rolling direction exceeds the longitudinal rigidity, which is effective in the rolling direction. This measure is based on the perception that, when driving around a bend, the outer region of the contact area is exposed to relatively high longitudinal shear forces, so that this outer region of the contact area can be used only relatively little for supporting side forces. The arrangement according to the invention allows the effects of the shear forces to be manipulated in favor of a beneficial transverse force transfer. The deliberate reduction of the longitudinal rigidity and/or the deliberate increase in the transverse rigidity proposed according to the invention provides for an increase of the lateral forces that can be transferred overall. In addition, an increase in camber side forces can be achieved.

In principle, such a design of the tire contact area can be realized by the use of a material, which is anisotropic with regard to the shearing rigidity. However, it is very difficult to create an anisotropic tire material of this type, since a tread material or rubber has to meet very high requirements with respect to grip, wear and chemical resistance, so that it could be difficult to integrate a wider range of shearing rigidity into the tire material mix of the contact area.

According to a preferred embodiment, it is therefore proposed for the contact area to have a number of lugs, which are shaped and arranged in such a way as to provide the contact area with a transverse rigidity which is greater than the longitudinal rigidity. In other words, in the case of a preferred embodiment, the desired deviation of the transverse rigidity from the longitudinal rigidity in the contact area is achieved by suitable shaping and positioning of the lugs.

In particular, a length of the tread lugs measured in the rolling direction may be less than the width measured transversely to the rolling direction. This design automatically has the effect that the lugs, and consequently the contact region, have a transverse rigidity which is greater than the associated longitudinal rigidity.

According to an especially advantageous embodiment, the tread lugs may have zones extending transversely to the rolling direction which are covered radially on the outside by the lug material when the tire is new and are exposed radially on the outside when a tire is worn down to a predetermined tread depth. The longitudinal rigidity of these lugs is less than that of the tread lugs of the new tire. This design allows compensation for wear-related stiffening of the tread lugs. For example, the transverse zones exposed by wearing may divide the respective tread lug and, already in this way reduce the longitudinal rigidity of the divided tread lugs. Furthermore, the transverse zones may also be shaped in such a way that the longitudinal rigidity reducing effect of the lugs increases with increasing wear. Transverse zones of this type may be formed, for example, by cavities in the lugs.

In an especially advantageous embodiment, the contact area may consist of a fiber-reinforced material, the fibers being oriented in such a way that the longitudinal rigidity of the contact region is less than its transverse rigidity. Introducing deliberately aligned fibers allows the shearing rigidity of the contact area in the transverse direction to be selectively increased, without at the same time significantly influencing the longitudinal and vertical rigidity of a lug. For this purpose, the fibers may expediently extend essentially transversely to the rolling direction and be inclined with respect to the road surface, in a projection oriented perpendicularly to the road. An inclination of between 30° and 60°, in particular of 45°, is preferred in this case.

It is understood that the features mentioned above and to be explained in greater detail below can be used not only in the respective specified combination but also in other combinations or on their own without departing from the scope of the present invention.

In the description which follows, the same reference numerals refer to the same or functionally the same or similar components.

### BRIEF DESCRIPTION OF THE DRAWINGS

FIG. 1 shows a cross section through a pneumatic tire,

FIG. 2 shows a diagram to explain the relationship between the tread shearing force (y-axis) and the tread shear strain (x-axis) along the length of the tire—road contact zone,

FIG. 3 shows a view perpendicular to the road surface of the contact zone,

FIG. 4 is a longitudinal sectional view of the tire tread including individual tread lugs corresponding to the section taken along line IV-IV in FIG. 3,

FIG. 5 shows a cross section through individual tread lugs in the section taken along line V-V in FIG. 3.

### DESCRIPTION OF PREFERRED EMBODIMENTS

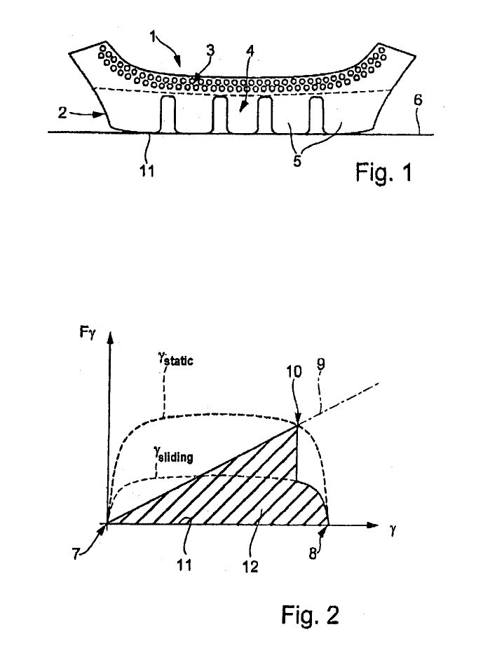

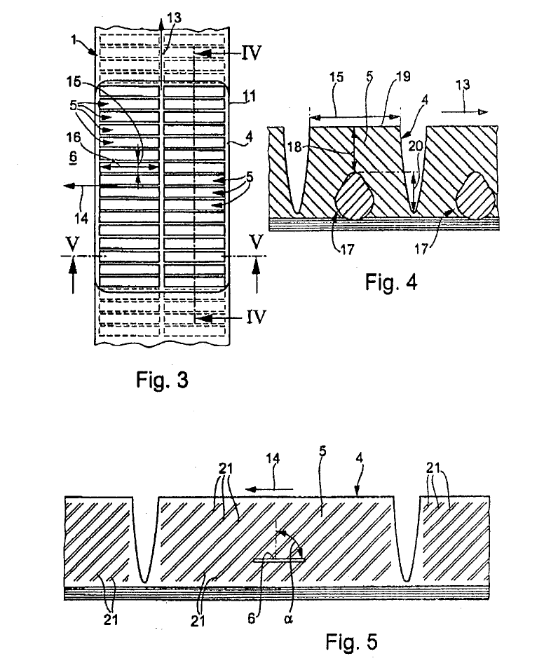

As shown in FIG. 1, a pneumatic tire 1 has a tread 2, which has radially on the inside thereof, an inner region 3 and radially on the outside an outer contact region 4. The inner region 3 is usually referred to as the tire belt and serves for the transfer of force between the tire 1 and a wheel rim (not shown). The outer contact region 4 is usually formed by the tread including lugs 5 of the tire 1 and serves for transferring shearing forces between the inner region 3 or the tire 1 and a road surface 6, with which the contact region 4 comes into contact when the tire 3 rolls along a road surface. The contact region momentarily in contact with the road surface is the contact zone 11 (cf. in particular FIG. 3).

In the diagram according to FIG. 2, the shearing force F_{γ}is plotted on the y-axis and the shear strain γ along the contact zone 11 between the contact region 4 and the road surface 6 is plotted on the x-axis. The contact zone 11 that is the area of contact between the road surface 6 and the contact region 4 begins at 7 when the tire 1 rolls along and is called run-in. The end of the contact between the contact region 4 and the road surface 6 during the rolling of the tire 1 is represented at 8 and is referred to as the run-out. In FIG. 2, the profile of the static friction limit γ_{static} along the contact zone 11 is plotted by a dashed line. The static friction limit γ_{static} corresponds to the maximum value of the shearing force transferable between the contact region 4 and the road surface 6. On account of the ground pressure distribution along the contact zone 11, an essentially symmetrical “dome-shaped” profile is obtained for the static friction limit γ_{static}. Also entered in FIG. 2, by a dotted line, is the sliding friction limit γ_{sliding}, which has a similar profile to the static friction limit γ_{static}, the shearing forces F_{γ} transferred under sliding friction lying distinctly below the static friction limit γ_{static}.

Beginning at the run-in 7 and ending at the run-out 8, an increasing deformation of the contact region 4 or of the tread lugs 5 builds up along the ground contact zone 11. This behavior is a result of the ground pressure distribution and the contact kinematics, in particular under slip and/or creep stress of the tire 1. Increasing shear strain, however, means at the same time an increasing transfer of shear forces between the road surface 6 and the contact region 4.

In the case of a conventional tire, a relationship 9 as indicated by a dash-dotted line is obtained, which represents a linear relationship between increasing deformation and simultaneously transferred side shear forces along the contact zone 11. Starting from the run-in 7, the transferable shear forces along the ground contact zone 11 therefore increase linearly, which is accompanied by a likewise linearly increasing shear deformation of the contact region 4. As soon as the shear forces transferred between the contact region 4 and road surface 6 reach the static friction limit γ_{static} at 10, the respective portion of the contact region 4 slides on the road surface 6. The shear forces still transferable between the contact region 4 and the road surface 6 then correspond to the sliding friction force. Accordingly, the relationship between the shear strain γ and the transferable shearing forces Fγ then follows the sliding friction limit γ_{sliding}. The hatched area denoted by 12 consequently indicates the lateral force transferred overall from the tire 1 along the ground contact zone 11.

It has been found that, when driving around a bend, the profile 9 reproduced in FIG. 2 also changes transversely to the rolling direction of the tire 1 within the contact zone 11. Outer regions of the contact zone 11 are then exposed to greater longitudinal strains than inner regions.

In FIG. 3, the region of the tire 1, which is in contact with the road surface 6 and comprises the contact zone 11 is shown. The viewing direction in this case is perpendicular to the road surface 6. A rolling direction of the tire 1 and a longitudinal direction, parallel thereto, of the contact region 4 or of the lugs 5 is indicated in FIG. 3 by an arrow 13. In a corresponding way, a transverse direction of the contact region 4 or of the tread lugs 5 is indicated by an arrow 14, this transverse direction 14 extending transversely or perpendicularly to the rolling direction 13.

According to the invention, the contact region 4 is constructed or formed in such a way that its longitudinal rigidity, effective in the rolling direction 13, is less than its transverse rigidity, which is effective transversely to the rolling direction 13. This is achieved with the embodiment shown here by the contact region 4 having a multiplicity of tread lugs 5, which are shaped and arranged in such a way that the desired relationship of the transverse rigidity with respect to the longitudinal rigidity of the contact region 4 is obtained. According to FIG. 3, for this purpose the individual lugs 5 are dimensioned in such a way that a lug length 15, measured in the rolling direction 13 is distinctly less than a lug width 16, measured transversely to the rolling direction 13. In the embodiment shown, the individual tread lugs 5 are approximately six times as wide as they are long. Consequently, the geometrical shape of the lugs 5 inevitably produces for each individual lug 5 a rigidity distribution in which the rigidity of the lugs 5 in the transverse direction 14 is greater than in the longitudinal direction 13. Since the sum of the lugs 5 form the contact region 4, the latter consequently has a transverse rigidity which is greater than its longitudinal rigidity. When driving around a bend, with this design consequently the proportion of tread area within the contact zone 11 that is involved in the lateral force transfer is increased. As a result, the overall lateral force transfer of the tire 1 can be improved. In particular, the effect of an increase in the camber side force transfer can also be achieved. For example, the driving impression of a wider tire 1 can be replicated on the basis of camber effects.

FIG. 4 shows an advantageous embodiment with transverse zones 17 incorporated or formed in the individual lugs 5. The material for these transverse zones 17 is selected in this case such that at least the longitudinal rigidity of these transverse zones 17 is less than the longitudinal rigidity of the tread lugs 5. These transverse zones 17 may expediently be formed by cavities. According to FIG. 4, the transverse zones 17 are positioned such that they are covered radially on the outside by the lug material when the tire 1 is new, that is there is a distance 18 between an outer side 19 of the lug and the transverse zone 17. The integration of these pliable transverse zones 17 allows the longitudinal rigidity of the respective tread lugs 5 to be reduced when the tire is worn.

One of the factors on which the longitudinal rigidity of a tread lug 5 depends is the lug height, measured perpendicularly to the road surface 6. The greater the lug height, the more flexible is the lug 5. With decreasing tread depth, therefore, the longitudinal rigidity of the lug 5 increases. With the integration of the transverse zones 17 thus the transverse zones are opened radially outwards when the tread is worn down to a predetermined tread depth 20. As a result, the respective lug 5 is divided in its longitudinal direction, so that its longitudinal rigidity decreases. The shaping and/or material selection of the transverse zones 17 is expediently chosen such that the longitudinal rigidity of the respective tread lug 5 does not decrease abruptly but steadily. Similarly, it is possible to compensate essentially for the increase in rigidity caused by the decrease in tread by corresponding shaping and/or material selection of the transverse zones 17, so that the longitudinal rigidity of the tread lugs 5 remains essentially constant during wear.

In addition or as an alternative to the geometrical measures already proposed, the rigidity of the contact region 4 or of the lugs 5 forming the contact region 4 can be influenced in one direction by unidirectional fibers 21 being incorporated into the material of the contact region 4 or of the lugs 5. These fibers 21 are oriented in such a way that the longitudinal rigidity of the contact region 4 or of the lugs 5 is less than the associated transverse rigidity. This is achieved, for example, by the fibers 21 extending essentially transversely to the rolling direction 13, in a projection oriented perpendicularly to the road surface 6, that is the fibers 21 have a directional component parallel to the transverse direction 14. Furthermore, the fibers 21 are inclined with respect to the road surface 6. In FIG. 5, an angle of inclination α, which is approximately 45°, is shown by way of example. In principle, other angles are also suitable for the inclination of the fibers 21 with respect to the road surface 6, for example the angle α may be chosen to be between 30° and 60°. To achieve the desired rigidity anisotropy of the contact region 4 or of the lugs 5, the fibers 21 extend essentially parallel to one another. In principle, it is also possible for the fibers 21 to cross one another and at the same time extend in a plane which is perpendicular to the rolling direction 13. Furthermore, the orientation of the fibers 21 may alternate from lug 5 to lug 5.

The fibers 21 may be glass fibers, carbon fibers or synthetic fibers.

What is claimed is:

1. A tire for vehicles, in particular multitrack motor vehicles, said tire having a contact region (4), which comes into contact with a road surface (6) during the rolling of the tire (1) while transferring shearing forces acting parallel to the road surface (6) between the road surface (6) and the tire (1), said contact region (4) of said tire having a longitudinal rigidity, in the rolling direction (13), which is less than the transverse rigidity, which is effective transversely to the rolling direction (13).

2. A tire according to claim 1, wherein said tire has tread lugs (5), which are shaped and arranged so as to provide for a contact region (4) having a transverse rigidity which is greater than the longitudinal rigidity of the contact region (4).

3. A tire according to claim 2, wherein the tread lugs (5) have a length (15) measured in the rolling direction (13) which is less than the width (16) of the lugs measured transversely to the rolling direction (13).

4. A tire according to claim 3, wherein the lug width (16) is two to eight times greater than the lug length (15).

5. A tire according to claim 2, wherein the tread lugs (5) enclose zones (17) which extend transversely to the rolling direction (13) and which are covered radially on the outside by the lug material when the tire (1) is new but which are exposed radially on the outside when of a tire (1) is worn down to a predetermined tread depth (20), and whose longitudinal rigidity is less than that of the tread lugs (5).

6. A tire according to claim 5, wherein the transverse zones (17) are formed by cavities.

7. A tire according to claim 1, wherein the contact region (4) of said tire consists of a fiber-reinforced material structure, the fibers (21) being oriented in such a way that the longitudinal rigidity of the contact region (4) is less than its transverse rigidity.

8. A tire according to claim 7, wherein essentially all the fibers (21) extend essentially transversely to the rolling direction (13), in a projection oriented perpendicularly to the road surface (6).

9. A tire according to claim 8, wherein essentially all the fibers (21) are inclined with respect to the road surface (6).

10. A tire according to claim 8, wherein essentially all the fibers (21) are inclined at an angle between 30° and 60° with respect to the road surface (6).

11. A tire according to claim 10, wherein the fibers extends at an angle of about 45° with respect to the road surface (6).

12. Tire according to one of claims 7, wherein essentially all the fibers (21) extend parallel to one another.

13. A tire according to claim 7, wherein essentially all the fibers (21) consist of one of glass fibers, carbon fibers, and synthetic fibers.
